(19) United States
(12) Patent Application Publication
(10) Pub. No.: US 2007/0165211 A1
(43) Pub. Date: Jul. 19, 2007

(54) Semiconductor manufacturing apparatus, semiconductor surface inspection apparatus, and surface inspection method

(76) Inventor: Akio Ishikawa, Tokyo (JP)

Correspondence Address: CHRISTIE, PARKER & HALE, LLP, PO BOX 7068, PASADENA, CA, 91109-7068, US

(21) Appl. No.: 11/655,407

(22) Filed: Jan. 19, 2007

(30) Foreign Application Priority Data
Jan. 19, 2006 (JP) 2006-010711

(51) Int. Cl. G01C 1/00

(52) U.S. Cl. 356/145

(57) ABSTRACT

Semiconductor manufacturing apparatus 1 that manufactures semiconductor devices by applying a prescribed processing on a sample 2 in a semiconductor manufacturing process includes: an image capturing unit 24 that captures the image of a surface of the sample 2 before and after the prescribed processing; a defect detection unit 28 that detects defects in the images of the sample 2 captured before and after the prescribed processing; and a defect increase/decrease detection unit 32 that detects the increase and decrease of defects which are found after the prescribed processing compared to before the prescribed processing.

### CROSS-REFERENCE TO RELATED APPLICATION

This application is based upon and claims the benefit of priority from the prior Japanese Patent Application No. 2006-10711, filed on Jan. 19, 2006, the entire contents of which are incorporated herein by reference.

### BACKGROUND OF THE INVENTION

1. Field of the Invention

The present invention relates to a semiconductor surface inspection apparatus and surface inspection method for detecting a defect appearing in a pattern formed on the surface of a sample in a semiconductor manufacturing process based on a captured image of the pattern formed on the surface of the sample, and a semiconductor manufacturing apparatus equipped with such a surface inspection apparatus.

2. Description of the Related Art

In a semiconductor manufacturing process, many chips (dies) are formed on a semiconductor wafer. Patterns are formed in multiple layers on each die. Each completed die is electrically tested using a prober and a tester, and any defective die is removed from the fabrication process.

In the semiconductor manufacturing process, the manufacturing yield is a very important factor, and the result of the electrical testing is fed back to the manufacturing process and used for the management of each process step. However, as the semiconductor manufacturing process consists of many process steps, it takes a very long time before the electrical testing can be conducted after the start of the manufacturing process; as a result, when a certain process step is found faulty as a result of the electrical testing, many wafers are already partway through the process, and the result of the electrical testing cannot be adequately utilized for improving the yield.

To address this, surface inspection is performed by capturing an image of a pattern formed at an intermediate step and checking the pattern for defects based on the thus captured image. If such surface inspection is performed at a plurality of steps in the manufacturing process, it becomes possible to detect any defect that has occurred after the previous inspection, and the result of the inspection can thus be promptly reflected in the process management.

FIG. 1 is a schematic diagram showing the configuration of a surface inspection apparatus similar to the one that the applicant of this patent application proposed in Japanese Unexamined Patent Publication No. 2004-177397. As shown, in the surface inspection apparatus 20, a sample holder (chuck stage) 22 is mounted on the upper surface of a stage 21 which is movable in two- or three-dimensional directions. A semiconductor wafer 3 as a sample to be inspected is placed on the sample holder 22 and held fixed thereon. An image capturing unit 24 constructed from a one-dimensional or two-dimensional CCD camera or the like is disposed above the stage, and the image capturing unit 24 generates an image signal by capturing an image of the pattern formed on the semiconductor wafer 3.

As shown in FIG. 2, a plurality of dies 3a are formed on the semiconductor wafer 3 in a matrix pattern repeating in X and Y directions. Since the same pattern is formed on each die, it is general practice to compare the images of corresponding portions between adjacent dies (die-to-die comparison). If there is no defect in the two adjacent dies, the gray level difference between them is smaller than a threshold value, but if there is a defect in either one of the dies, the gray level difference is larger than the threshold value (single detection). At this stage, however, this is no way to know which die contains the defect; therefore, the die is further compared with a die adjacent on a different side and, if the gray level difference in the same portion is larger than the threshold value, then it is determined that the die under inspection contains the defect (double detection).

Further, in a semiconductor memory or the like, repeated patterns of a basic unit called a cell are formed on each die 3a, with one cell pattern as the basic pattern. When inspecting the pattern in which such cells are arranged, the presence or absence of a defect is checked, not by the die-to-die comparison described above, but by comparing the corresponding image data between adjacent cells (cell-to-cell comparison).

The image capturing unit 24 comprises a one-dimensional CCD camera, and the stage 21 is moved so that the camera moves (scans) relative to the semiconductor wafer 3 at a constant speed in the X or the Y direction. Image signals are converted into multi-valued digital signals (gray level signals) and stored in an image storage unit 25.

When the gray level signals (inspection image signals) representing the adjacent two dies (in the cell-to-cell comparison, adjacent two cells) are stored in the image storage unit 25, the gray level signals representing small sub-images (called logical frames) taken from the corresponding portions of the two adjacent dies (or cells) are read out of the image storage unit 25 and supplied to a difference detection unit 26. Actually, processing such as fine registration is also performed, but a detailed description of such processing will not be given.

The gray level signals representing the sub-images taken from the corresponding portions of the two adjacent dies (or cells) are thus input to the difference detection unit 26. The difference detection unit 26 calculates the difference (gray level difference) between the gray level signals of the respectively corresponding pixels by taking one sub-image as an inspection image and the other as a reference image, and supplies the difference to a detection threshold value calculation unit 27 and a defect detection unit 28. The detection threshold value calculation unit 27 automatically determines the detection threshold value in accordance with the distribution of the gray level difference, and supplies the detection threshold value to the defect detection unit 28. The defect detection unit 28 compares the gray level difference with the thus determined threshold value to judge whether the portion under inspection contains a defect or not. Then, for each portion that has been judged to contain a defect, the defect detection unit 28 outputs defect information which includes such information as the position and size of the defect, the type of the defect, the position of the defect, the gray level difference, the detection threshold value used for the detection, the defect detection parameter used to determine the detection threshold value, and the image data of the defective portion containing the defect.

Generally, the noise level of a semiconductor pattern differs depending on the kind of the pattern such as the pattern of a memory cell portion, the pattern of a logic circuit portion, the pattern of a wiring portion, or the pattern of an analog circuit portion. Correspondence between the portion and the kind of the semiconductor pattern can be found from the design data. Therefore, the detection threshold value calculation unit 27 automatically determines the threshold value for each portion, for example, in accordance with the distribution of the gray level difference in that portion, and the defect detection unit 28 performs the above judgment by using the threshold value determined for each portion.

However, whether a defect detected in the surface inspection performed after a certain process step (hereinafter referred to as the “subsequent surface inspection”) occurs during the immediately previous process may be uncertain.

This can occur, for example, when the defect already existing at the time of the surface inspection performed before that process step (hereinafter referred to as the “previous surface inspection”) was not detected because a relatively large detection threshold value was used in the previous surface inspection, but was detected in the subsequent surface inspection because a relatively small detection threshold value was used.

Here, and as, in the previous surface inspection, defect information only for the detected defect is generated, it is not possible to know in what condition the portion of the defect detected in the subsequent surface inspection was at the time of the previous surface inspection. There is therefore no knowing whether the defect detected in the subsequent surface inspection was really one that occurred in that step or one that had occurred before that step but went undetected in the previous surface inspection; as a result, it has not been possible to reliably determine whether the fault lies in that step or not.

Furthermore, as the surface inspection is not performed at every process step but is performed once in every plurality of steps by skipping intermediate steps, there has been the problem that, if a defect occurs in a certain step, the defect may be concealed, for example, in a subsequent metal film deposition step before undergoing a surface inspection, resulting in an inability to detect such a defect in the subsequent surface inspection.

### SUMMARY OF THE INVENTION

In view of the above problems, it is an object of the present invention to provide a semiconductor surface inspection apparatus, surface inspection method, and semiconductor manufacturing apparatus that can identify a defect that has newly occurred or disappeared during the processing of a particular step in a semiconductor manufacturing process.

In order to accomplish the above object, according to the present invention, a semiconductor manufacturing apparatus that applies the prescribed processing on a sample in a semiconductor manufacturing process includes a surface inspection means. Thus, a defect inspection is performed before and after the prescribed processing in order to detect the increase and decrease of defects that are found after the prescribed processing compared to before the prescribed processing.

As defect detection is performed before and after the prescribed processing, the fact that a defect found to have increased after the processing occurs due to the processing can be highly precisely recognized. Moreover, a defect that disappears during the processing can be detected before the processing.

Moreover, as a process having a drawback can be highly precisely identified during a surface inspection in accordance with the present invention, the result of detection of a defect that is found to have increased after the prescribed processing compared to before the prescribed processing can be used to detect a fault in the semiconductor manufacturing apparatus.

Furthermore, according to the present invention, a determination is made on whether a defect detected in surface inspections performed one of before and after the prescribed processing exists in an image captured the other of before and after the prescribed process. This determination makes it possible to select a part, which suffers a defect that has not been detected although it exists the other of before and after the prescribed processing, and to recheck the part for the presence or absence of the defect. Thus, a defect that is found to have increased or decreased after the prescribed processing compared to before the prescribed processing can be identified more highly precisely.

According to the first aspect of the present invention, there is provided semiconductor manufacturing apparatus that manufactures semiconductor devices by applying prescribed processing on a sample in a semiconductor manufacturing process. The semiconductor manufacturing apparatus includes: an image capturing unit that captures the image of a surface of the sample before and after the prescribed processing; a defect detection unit that detects defects in images of the sample captured before and after the prescribed processing; and a defect increase/decrease detection unit that detects the increase and decrease of defects which are found after the prescribed processing compared to before the prescribed processing.

According to the second aspect of the present invention, there is provided an semiconductor surface inspection apparatus that is provided to semiconductor manufacturing apparatus which manufactures semiconductor devices by applying the prescribed processing on a sample in a semiconductor manufacturing process, and that detects a defect existing on a sample based on an image captured of the surface of the sample. The semiconductor surface inspection apparatus includes: an image capturing unit that captures the image of a surface of the sample before and after the prescribed processing; a defect detection unit that detects defects in images of the sample captured before and after the prescribed processing; and a defect increase/decrease detection unit that detects the increase and decrease of defects which are found after the prescribed processing compared to before the predetermined processing.

The semiconductor manufacturing apparatus and the semiconductor surface inspection apparatus may include a fault detection unit that detects a fault in the semiconductor manufacturing apparatus based on a result of detection of defects that are found to have increased after the prescribed processing compared to before the prescribed processing. The fault detection unit may detect a fault in the semiconductor manufacturing apparatus based on the number of increased defects, the type thereof, the distribution thereof, or the size thereof. The fault detection block may further detect a faulty portion of the semiconductor manufacturing apparatus based on the type of increased defects, the distribution thereof, or the size thereof.

Furthermore, the semiconductor manufacturing apparatus and semiconductor surface inspection apparatus may include a defect presence/absence determination unit that determines whether a defect which the defect detection unit has detected in an image captured one of before and after the prescribed processing exists in an image captured the other of before and after the prescribed processing. The defect presence/absence determination unit may determine whether a defect detected in the image captured one of before and after the prescribed processing but not detected in the image captured the other of before and after the prescribed processing exists in the image captured the other of before and after the prescribed processing.

Moreover, the semiconductor manufacturing apparatus and semiconductor surface inspection apparatus may include a false defect determination unit that determines whether a defect which the defect detection unit has detected in an image captured one of before and after the prescribed processing is a false defect. The false defect determination unit may determine whether a defect that is detected in the image captured one of before and after the predetermined processing but not detected in the image captured the other of before and after the prescribed processing exists in the image captured the one of before and after the prescribed processing.

According to the third aspect of the present invention, there is provided a surface inspection method for detecting a defect existing on a sample based on an image captured of the surface of the sample to which the prescribed processing is applied in a semiconductor manufacturing process. According to the surface inspection method, the image of a surface of the sample is captured before and after the prescribed processing. Defects in images of the sample captured before and after the prescribed processing are detected. The increase and decrease of defects that are found after the prescribed processing compared to before the predetermined processing are then detected.

### BRIEF DESCRIPTION OF THE DRAWINGS

These and other objects and features of the present invention will become clearer from the following description of the preferred embodiments given with reference to the attached drawings, wherein:

FIG. 1 is a schematic diagram showing the configuration of a semiconductor surface inspection apparatus according to the prior art;

FIG. 2 is a diagram showing an arrangement of dies on a semiconductor wafer;

FIG. 3 is a schematic diagram showing the configuration of a semiconductor manufacturing apparatus according to an embodiment of the present invention; and

FIG. 4 is a diagram showing a configuration example of a semiconductor surface inspection unit shown in FIG. 3.

### DESCRIPTION OF THE PREFERRED EMBODIMENTS

Preferred embodiments of the present invention will be described in detail below while referring to the attached figures. FIG. 3 is a schematic diagram showing the configuration of a semiconductor manufacturing apparatus according to an embodiment of the present invention.

The semiconductor manufacturing apparatus 1 comprises: a sample processing unit 10 as a conventional semiconductor manufacturing apparatus, such as a lithography apparatus, a CVD apparatus, a PVD apparatus, or a CMP apparatus, which applies a prescribed processing to a semiconductor wafer as a sample; a semiconductor surface inspection unit 20 as a semiconductor surface inspection apparatus according to the present invention, which detects a defects on the semiconductor wafer based on an image captured of the surface of the wafer; and a transport unit 40 which transports the wafer to and from the semiconductor manufacturing apparatus 1 as well as within the apparatus 1.

A plurality of semiconductor wafers (for example, 25 wafers) are accommodated in a wafer cassette 50 and loaded into the semiconductor manufacturing apparatus 1. When the wafer cassette 50 is loaded into the transport unit 40 of the semiconductor manufacturing apparatus 1, a first wafer arm 41 of the transport unit 40 removes only one wafer at a time from the cassette 50 and transports it along a passage 91 to the semiconductor surface inspection unit 20.

When the semiconductor wafer is carried to the semiconductor surface inspection unit 20, the semiconductor surface inspection unit 20 captures the image of the surface of the wafer before the processing by the sample processing unit 10 (the image will hereinafter be referred to as the “image captured before the processing”). After detecting defects on the wafer surface using the image captured before the processing, the semiconductor surface inspection unit 20 generates and stores defect information on each of the detected defects, and also stores the image captured before the processing. The configuration of the semiconductor surface inspection unit 20 will be described later.

Thereafter, a second wafer arm 42 included in the transport unit 40 transports the wafer to the sample processing unit 10 along a route 92. The prescribed processing according to the kind of the semiconductor manufacturing apparatus 1 is then applied to the wafer. The prescribed processing may be lithography, CVD, PVD, or CMP.

After the prescribed processing is applied, the semiconductor wafer is transported to the semiconductor surface inspection unit 20 along a route 93 by the first wafer arm 41.

The semiconductor surface inspection unit 20 captures the image of the surface of the wafer after the processing by the sample processing unit 10 (the image will hereinafter be referred to as the “image captured after the processing”). After detecting defects on the wafer surface using the image captured after the processing, the semiconductor surface inspection unit 20 generates defect information on each of the detected defects. The semiconductor surface inspection unit 20 then compares the defect information on each of the defects detected in the image captured before the processing with the defect information on each of the defects detected in the image captured after the processing. Thus, the increase and decrease of the defects that is found after processing compared to before processing is detected.

The wafer whose inspection by the semiconductor surface inspection unit 20 is completed is returned to the wafer cassette 50 along the route 93 by the first wafer arm 41.

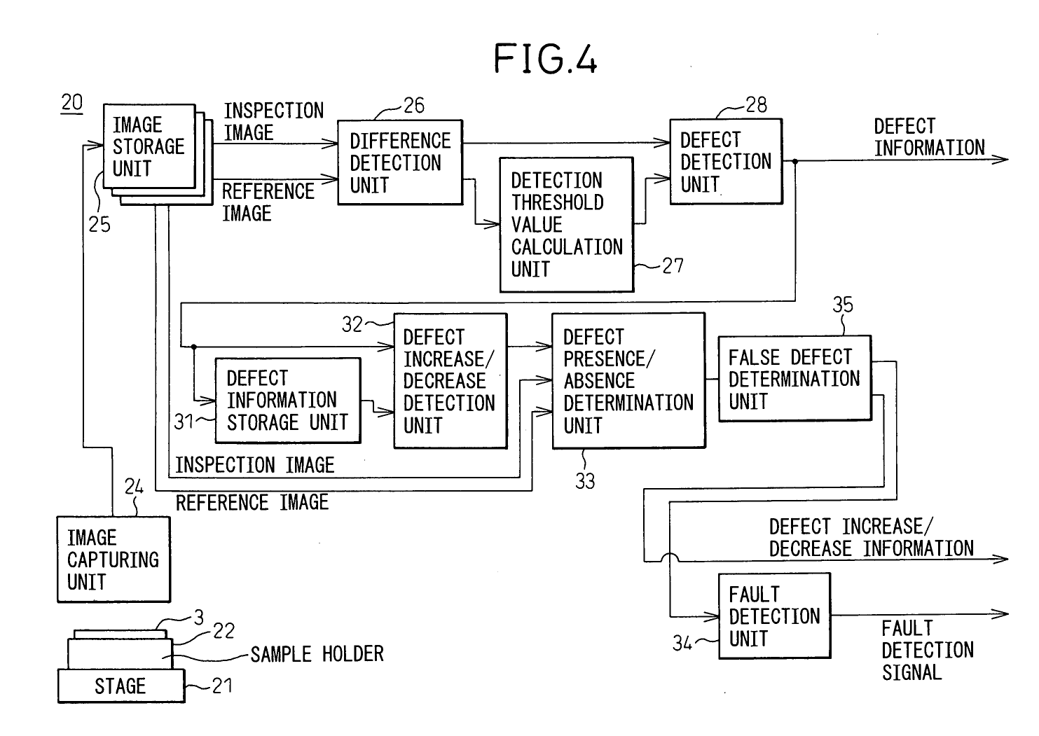

FIG. 4 is a diagram showing the configuration example of the semiconductor surface inspection unit shown in FIG. 3. As shown in FIG. 4, the semiconductor surface inspection unit 20 includes a stage 21 that is movable in directions of two or three dimensions, and a sample holder (chuck stage) 22 disposed on the stage 21.

The image capturing unit 24 constructed from a one-dimensional or two-dimensional CCD camera is disposed above the stage 21. The image capturing unit 24 is used to capture the image of the surface of the wafer 3, which is transported into the semiconductor surface inspection unit 20, before and after the processing to be applied by the sample processing unit 10. The image captured before the processing and the image captured after the processing by the image capturing unit 24 thereby are stored in an image storage unit 25 included in the semiconductor surface inspection unit 20.

The semiconductor surface inspection unit 20 includes a difference detection unit 26, a detection threshold value calculation unit 27, and a defect detection unit 28 for the purpose of detecting defects exists in each of images captured before and after processing.

The difference detection unit 26 compares images of corresponding parts of two adjoining dice (two adjoining cells for cell-to-cell comparison) which are contained in a image stored in the image storage unit 25, and computes a difference signal (gray level difference signal).

Images of the multiple wafers 3 may be stored in the image storage unit 25, and may be compared with one another in order to detect defects. In this case, the difference detection unit 26 compares corresponding parts in the two wafer images, and computes a gray level difference signal representing a difference in a gray level between the images.

The detection threshold value calculation unit 27 autonomously determines a detection threshold value according to the distribution of gray level difference signals computed by the difference detection unit 26.

The defect detection unit 28 compares a gray level difference, which is computed by the difference detection unit 26, with a threshold determined by the detection threshold value calculation unit 27, and thus determines whether the portion under inspection contains a defect or not. For each portion judged as a defect or for each defect, the defect detection unit 28 outputs defect information including the position of the defect, the size thereof, the type thereof, a gray level difference relative thereto, a detection threshold value employed for detection of the defect, defect detection parameters employed in determining the detection threshold value, and image data of a defective portion where the defect exists.

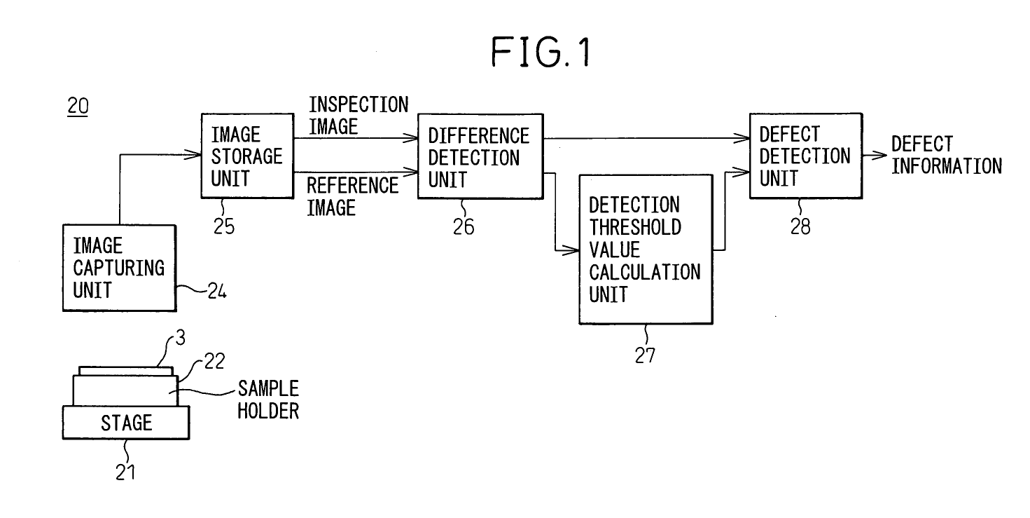

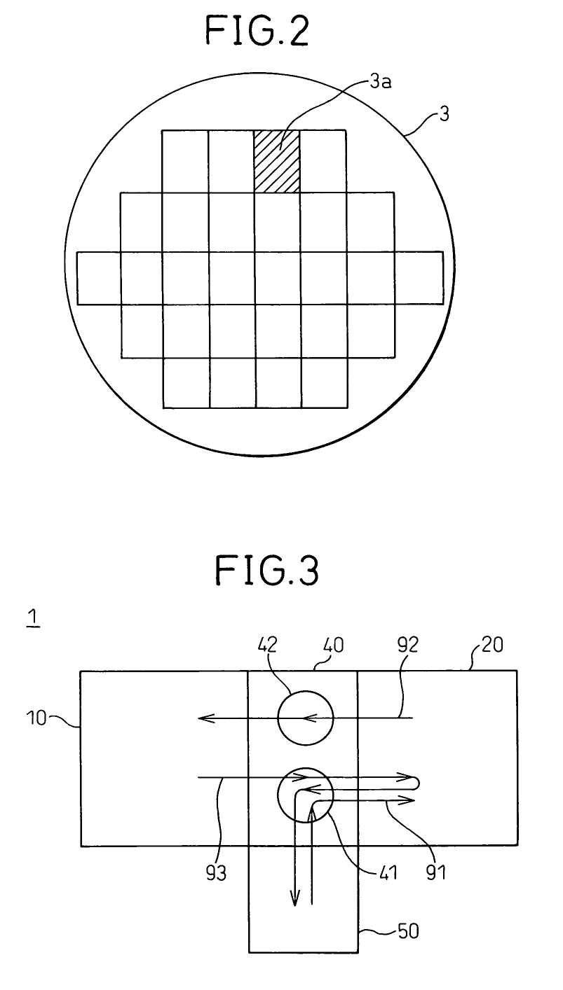

The functions of the components 26 to 28 are identical to those of the components 26 to 28 included in the conventional surface inspection apparatus described with reference to FIG. 1. The iterative description will be omitted.

The semiconductor surface inspection unit 20 further includes a defect information storage unit 31 in which defect information outputted from the defect detection unit 28 is stored. The defect information storage unit 31 is used to preserve pieces of defect information on respective defects detected in an image captured before the processing until defect detection is performed in an image captured after the processing. This allows comparison the pieces of defect information on the respective defects, which are detected in the image captured before the processing, with pieces of defect information on respective defects detected in the image captured after the processing.

Moreover, the defect information storage unit 31 may be used to temporarily hold the pieces of defect information on the respective defects detected in the image captured after the processing.

The semiconductor surface inspection unit 20 further includes a defect increase/decrease detection unit 32 that detects the increase and decrease of defects which is found after the prescribed processing compared to before the prescribed processing.

The defect increase/decrease detection unit 32 determines whether defect information on each of defects detected in an image captured before the processing, which is stored in the defect information storage unit 31, is identical to defect information on each of defects detected in an image captured after the processing which is provided by the defect detection unit 28 or stored in the defect information storage unit 31.

The defect increase/decrease detection unit 32 detects a defect existing in an image captured after the processing but not existing in an image captured before the processing and regards it as an increased defect. The defect increase/decrease detection unit 32 detects a defect existing in the image captured before the processing but not existing in the image captures after the processing and regards it as a vanished defect.

Whether defects detected before and after the processing are identical to each other may be decided based on at least pieces of positional information on the defects which are included in the respective pieces of defect information on the defects. For deciding whether defects are identical to each other, the sizes of the defects, the types thereof, and the gray level differences between them which are included in the respective pieces of defect information may be taken into account.

Defect information on a defect detected to have increased and/or defect information on a defect detected to have disappeared by the defect increase/decrease detection unit 32 are transferred to a defect presence/absence determination unit 33.

The defect presence/absence determination unit 33 determines whether an increased defect exists in an image captured before the processing. In other words, the defect presence/absence determination unit 33 determines whether a defect is located at the same position as the position of a defective part containing the increased defect, in the image captured before the processing.

Therefore, the defect presence/absence determination unit 33 rechecks whether each of defects, which are recognized to have increased by the defect increase/decrease detection unit 32, is a defect exists in an image captured before the processing but cannot be detected during an inspection performed before the processing.

Moreover, the defect presence/absence determination unit 33 determines whether a vanished defect exists in an image captured after the processing. In other words, the defect presence/absence determination unit 33 determines whether a defect is located at the same position as the position of defective part containing a vanished defect, in the image captured after the processing.

Therefore, the defect presence/absence determination unit 33 rechecks whether each defect, which are recognized to have disappeared by the defect increase/decrease detection unit 32, is a defect existing in an image captured after the processing but cannot be detected during an inspection performed after processing.

When the defect presence/absence determination unit 33 determines on the presence or absence of a defect, it acts as described below.

For determining whether an increased defect exists in an image captured before the processing, the defect presence/absence determination unit 33 selects a partial image of the position where the increased defect is detected, from each of an image captured before the processing and an image captured after the processing, and compares the partial images with each other. If a difference between the partial images is limited, a determination may be made that the defect has been present in the defective position since before the processing. If the difference is large, a determination may be made that the defect has been absent from the defective position before the processing.

Otherwise, the defect presence/absence determination unit 33 may perform the same processing as image comparison, which is performed by the difference detection unit 26, the detection threshold value calculation unit 27, and the defect detection unit 28, on an image captured before the processing preserved in the image storage unit 25 while modifying a condition for inspection (for example, increasing the detective sensitivity or modifying an area to be inspected). The defect presence/absence determination unit 33 may then determine whether a defect is really present at the position where the increased defect is detected.

For the foregoing processing, when an image captured before the processing is stored in the image storage unit 25, the image storage unit 25 may hold the image captured before the processing until defect presence/absence determination performed by the defect presence/absence determination unit 33 is completed.

The semiconductor surface inspection unit 20 is provided to the semiconductor manufacturing apparatus 1. When such an surface inspection means is provided to the semiconductor manufacturing apparatus 1, it is advantageous in that a picture image of a sample captured before the processing applied by the semiconductor manufacturing apparatus 1 can be preserved using a relatively small storage capacity even after the completion of the processing.

That is, when the semiconductor surface inspection unit 20 is provided as a separate apparatus from the semiconductor manufacturing apparatus 1, it becomes necessary to provide a storage capacity equivalent to the number of wafers that can be accommodated in the wafer cassette 50 (usually, 25 wafers) and in units of which the semiconductor wafers 3 are handled, but when the semiconductor surface inspection unit 20 is incorporated in the semiconductor manufacturing apparatus 1 as described above, the number of captured images to be stored is at most three, one for the wafer currently under processing, one for the wafer held in the transport unit 40, and one for the wafer currently under surface inspection.

On the other hand, when whether a vanished defect exists in an image captured after processing is decided, the defect presence/absence determination unit 33 selects a partial image of the position where the vanished defect is detected, from each of an image captured before the processing and an image captured after the processing, and compares the partial images with each other. If a difference between the partial images is limited, a determination may be made that the defect has been present in the defective position even after the processing. If the difference is large, a determination may be made that the defect has been absent from the defective position after the processing.

Moreover, the defect presence/absence determination unit 33 may perform the same processing as image comparison, which is performed by the difference detection unit 26, the detection threshold value calculation unit 27, and the defect detection unit 28, on an image captured after the processing preserved in the image storage unit 25 while modifying a condition for inspection (for example, increasing the detective sensitivity or modifying an area to be inspected). The defect presence/absence determination unit 33 may then determine whether a defect is really present at the position where the vanished defect is detected.

Defect information on a defect that is detected to have increased or disappeared by the defect increase/decrease detection unit 32, or defect information on a defect recognized to have increased or disappeared as a result of determination made by the defect presence/absence determination unit 33 is transferred to a false defect determination unit 35. The false defect determination unit 35 then determinates whether the defect is a false defect.

The false defect determination unit 35 rechecks increased defects, that is, defects that are detected in an image captured after the processing but are not detected in an image captured before the processing to determine if they surely exist in the image captured after the processing while modifying a condition for inspection (for example, decreasing the detective sensitivity or modifying an area to be inspected).

Otherwise, the false defect determination unit 35 rechecks vanished defects, that is, defects that are detected in an image captured before the processing but are not detected in an image captured after the processing to determine if they surely exist in the image captured before the processing while modifying a condition for inspection (for example, increasing the detective sensitivity or modifying an area to be inspected).

When the false defect determination unit 35 determines a false defect, the false defect determination unit 35 may perform the same processing as image comparison, which is performed by the difference detection unit 26, the detection threshold value calculation unit 27, and the defect detection unit 28, on an image in which the defect is detected, while modifying a condition for inspection (for example, modifying the detective sensitivity or modifying an area to be inspected). The false defect determination unit 35 may then determine whether a defect is still detected at the position where the defect was detected.

Moreover, the false defect determination unit 35 may select a partial image of the position where the increased or vanished defect is detected, from each of an image captured before the processing and an image captured after the processing, and compare the partial images with each other. If a difference between the partial images is limited, the detected defect may be recognized as a false defect. If the difference is large, the detected defect may be recognized as a true defect.

Defect information on a defect that is detected to have increased by the defect increase/decrease detection unit 32, or defect information on a defect recognized as an increased defect as a result of determination made by the defect presence/absence determination unit 33 is transferred to a fault detection unit 34. Moreover, defect information on a defect recognized as an increased defect but not recognized as a false defect by the false defect determination unit 35 (that is, a true defect) is transferred to the fault detection unit 34.

The fault detection unit 34 detects a fault in the semiconductor manufacturing apparatus 1 according to the result of detection of defects that are recognized to have occurred during the processing applied by the semiconductor manufacturing apparatus 1. The fault detection unit 34 can detect a fault in the semiconductor manufacturing apparatus 1 according to any of the number of defects, the type thereof, the distribution thereof, and the size thereof.

For example, when the number of increased defects is equal to or larger than a prescribed value, the fault detection unit 34 may determine that the semiconductor manufacturing apparatus 1 has a drawback, and may thus detect a fault in the semiconductor manufacturing apparatus 1. Alternatively, when an abnormal defect larger than a prescribed area is generated, a fault in the semiconductor manufacturing apparatus 1 may be detected.

When a defect-causing material or the like can be deduced, for example, from the kind, size, or shape of the defect, the portion where the defect-causing material is used can be identified as being a faulty portion. It is also possible to locate a faulty portion, such as a portion affected by an accumulation of dirt, for example, in a gas outlet, based on the position where defects concentrate or the degree of concentration or the distribution thereof.

When a fault is detected in the semiconductor manufacturing apparatus 1, the fault detection unit 34 outputs a fault detection signal indicating the detection and the position of the fault. The fault detection signal may be displayed on a display device and used as a warning signal urging an operator to perform maintenance of the semiconductor manufacturing apparatus 1, or may be used as a self-diagnostic signal in the semiconductor manufacturing apparatus 1 for causing the maintenance of the semiconductor manufacturing apparatus 1 (for example, automatic cleaning of the specified portion within the apparatus) to start in response to the fault detection signal.

The difference detection unit 26, the detection threshold value calculation unit 27, the defect detection unit 28, the defect increase/decrease detection unit 32, the defect presence/absence determination unit 33, the fault detection unit 34, and the false defect determination unit 35 may be implemented in hardware circuits configured to implement the respective functions, or in software modules to be executed by a single or a plurality of information processing apparatuses (computers, etc.) to implement the respective functions.

According to the present invention, it becomes possible to determine whether a defect detected after a given step in the semiconductor manufacturing process is one that occurred after the inspection performed in that step, and the faulty step can thus be identified with good accuracy. Furthermore, according to the present invention, it becomes possible to capture a defect that has disappeared during a given step in the semiconductor manufacturing process.

Conventionally, whether defects detected in a prescribed process truly occur in the process cannot be determined. It is therefore hard to automatically determine on the presence or absence of a fault in semiconductor manufacturing apparatus, which is responsible for the process, or a faulty portion of the semiconductor manufacturing apparatus on the basis of such detected defects. According to the present invention, whether the process has a drawback can be highly precisely determined. The presence or absence of a fault in the semiconductor apparatus responsible for the process or the faulty portion thereof can be highly precisely and automatically determined based on the number of detected defects, the size thereof, the type thereof, or the distribution thereof.

Furthermore, by determining whether a defect detected during a surface inspection performed one of before and after the prescribed processing exists in a image captured the other of before and after the processing, a part suffering the defect that cannot be detected although it exists the other of before and after the prescribed processing can be closely reinspected.

As described previously, when a surface inspection means is provided to a semiconductor manufacturing apparatus, a storage capacity needed to preserve images captured before and after the prescribed processing can be saved.

That is, in order to decide whether a defect detected during a surface inspection performed after the prescribed processing exists in an image captured before the processing, the image captured before the processing should be preserved during the processing. However, as the samples such as semiconductor wafers are usually handled by accommodating a plurality of samples (usually, 25 samples) in one cassette, if the semiconductor surface inspection apparatus is provided as a separate apparatus from the semiconductor manufacturing apparatus, the apparatus must be configured so as to be able to store the captured images for all the samples accommodated in one cassette; otherwise, it would be inconvenient to handle the wafers.

Since the captured images used in the surface inspection apparatus are very high resolution, the amount of data for each captured image is extremely large, and it is not realistic to use a storage medium to store the captured images for all the samples accommodated in the cassette.

When the semiconductor surface inspection apparatus is incorporated as part of the semiconductor manufacturing apparatus as earlier described, the amount of data to be stored can be greatly reduced, because it is sufficient to store as many images as there are samples currently being processed in the semiconductor manufacturing apparatus.

The present invention is applicable to a semiconductor surface inspection apparatus and surface inspection method for detecting a defect appearing in a pattern formed on the surface of a sample in a semiconductor manufacturing process based on an image captured of the pattern formed on the surface of the sample, and a semiconductor manufacturing apparatus equipped with such a surface inspection apparatus.

While the invention has been described with reference to specific embodiments chosen for purpose of illustration, it should be apparent that numerous modifications could be made thereto, by those skilled in the art, without departing from the basis concept and scope of the invention.

What is claimed is:

1. Semiconductor manufacturing apparatus that manufactures semiconductor devices by applying prescribed processing to a sample in a semiconductor manufacturing process, comprising:
an image capturing unit which captures the image of a surface of said sample before and after said prescribed processing;
a defect detection unit which detects defects in images of said sample captured before and after said prescribed processing; and
a defect increase/decrease detection unit which detects the increase and decrease of defects which are found after said prescribed processing compared to before said prescribed processing.

2. The semiconductor manufacturing apparatus as claimed in claim 1, further comprising a fault detection unit which detects a fault in said apparatus based on a result of detection of defects which are found to have increased after said prescribed processing compared to before said prescribed processing.

3. The semiconductor manufacturing apparatus as claimed in claim 2, wherein said fault detection unit detects a fault in said apparatus based on any of the number of increased defects, the type thereof, the distribution thereof, and the size thereof.

4. The semiconductor manufacturing apparatus as claimed in claim 2, wherein said fault detection unit detects a faulty portion in said apparatus based on any of the type of increased defects, the distribution thereof, and the size thereof.

5. The semiconductor manufacturing apparatus as claimed in claim 1, further comprising a defect presence/absence determination unit which determines whether a defect, which said defect detection unit has detected in an image captured one of before and after said prescribed processing, exists in an image captured the other of before and after said prescribed processing.

6. The semiconductor manufacturing apparatus as claimed in claim 5, wherein said defect presence/absence determination unit determines whether a defect which is detected in said image captured one of before and after said prescribed processing but is not detected in said image captured the other of before and after said prescribed processing exists in said image captured the other of before and after said prescribed processing.

7. The semiconductor manufacturing apparatus as claimed in claim 1, further comprising a false defect determination unit which determines whether a defect which said defect detection unit has detected in an image captured one of before and after said prescribed processing is a false defect.

8. The semiconductor manufacturing apparatus as claimed in claim 7, wherein said false defect determination unit determines whether a defect which is detected in said image captured one of before and after said prescribed processing but is not detected in said image captured the other of before and after said prescribed processing exists in said image captured the one of before and after said prescribed processing.

9. A semiconductor surface inspection apparatus which is provided to semiconductor manufacturing apparatus which manufactures semiconductor devices by applying prescribed processing on a sample in a semiconductor manufacturing process, and which detects a defect existing on a sample based on an image captured of the surface of said sample, comprising:
an image capturing unit which captures the image of a surface of said sample before and after said prescribed processing;
a defect detection unit which detects defects in images of said sample captured before and after said prescribed processing; and
a defect increase/decrease detection unit which detects the increase and decrease of defects which are found after said prescribed processing compared to before said prescribed processing.

10. The semiconductor surface inspection apparatus as claimed in claim 9, further comprising a fault detection unit which detects a fault in said semiconductor manufacturing apparatus based on a result of detection of defects which are found to have increased after said prescribed processing compared to before said prescribed processing.

11. The semiconductor surface inspection apparatus as claimed in claim 10, wherein said fault detection unit detects a fault in said semiconductor manufacturing apparatus based on any of the number of increased defects, the type thereof, the distribution thereof, and the size thereof.

12. The semiconductor surface inspection apparatus as claimed in claim 10, wherein said fault detection unit detects a faulty portion in said semiconductor manufacturing apparatus based on any of the type of increased defects, the distribution thereof, and the size thereof.

13. The semiconductor surface inspection apparatus as claimed in claim 9, further comprising a defect presence/absence determination unit which determines whether a defect, which said defect decision unit has detected in an image captured one of before and after said prescribed processing, exists in an image captured the other of before and after said prescribed processing.

14. The semiconductor surface inspection apparatus as claimed in claim 13, wherein said defect presence/absence determination unit determines whether a defect which is detected in said image captured one of before and after said prescribed processing but is not detected in said image captured the other of before and after said prescribed processing exists in said image captured the other of before and after said prescribed processing.

15. The semiconductor surface inspection apparatus as claimed in claim 9, further comprising a false defect determination unit which determines whether a defect which said defect detection unit has detected in an image captured one of before and after said prescribed processing is a false defect.

16. The semiconductor surface inspection apparatus as claimed in claim 15, wherein said false defect determination unit determines whether a defect which is detected in said image captured one of before and after said prescribed processing but is not detected in said image captured the other of before and after said prescribed processing exists in said image captured the one of before and after said prescribed processing.

17. A surface inspection method for detecting a defect existing on a sample based on an image captured of the surface of said sample to which a prescribed processing is applied in a semiconductor manufacturing process, comprising:
capturing the image of a surface of said sample before and after said prescribed processing;
detecting defects in images of said sample captured before and after said prescribed processing; and
detecting the increase and decrease of defects which are found after said prescribed processing compared to before said prescribed processing.

18. The surface inspection method as claimed in claim 17, wherein a fault in semiconductor manufacturing apparatus that applies said prescribed processing is detected based on a result of detection of defects which are found to have increased after said prescribed processing compared to before said prescribed processing.

19. The surface inspection method as claimed in claim 18, wherein a fault in said semiconductor manufacturing apparatus is detected based on any of the number of increased defects, the type thereof, the distribution thereof, and the size thereof.

20. The surface inspection method as claimed in claim 18, wherein a faulty portion in said semiconductor manufacturing apparatus is detected based on any of the type of increased defects, the distribution thereof, and the size thereof.

21. The surface inspection method as claimed in claim 17, wherein whether a defect detected in an image captured one of before and after said prescribed processing exist in an image captured the other of before and after said prescribed processing is determined.

22. The surface inspection method as claimed in claim 21, wherein whether a defect detected in said image captured one of before and after said prescribed processing but is not detected in said image captured the other of before and after said prescribed processing exists in said image captured the other of before and after said prescribed processing.

23. The surface inspection method as claimed in claim 17, wherein whether a defect detected in an image captured one of before and after said prescribed processing is a false defect is determined.

24. The surface inspection method as claimed in claim 23, wherein whether a defect which is detected in said image captured one of before and after said prescribed processing but is not detected in said image captured the other of before and after prescribed processing exists in said image captured the one of before and after said prescribed processing is determined in order to determine whether the defect detected in said image captured the one of before and after prescribed processing is a false defect.
